(19) United States
(12) Patent Application Publication
(10) Pub. No.: US 2014/0223703 A1
(43) Pub. Date: Aug. 14, 2014

(54) Seatbelt Q - Release

(71) Applicant: Albert Ammons, Chicago, IL (US)

(72) Inventor: Albert Ammons, Chicago, IL (US)

(21) Appl. No.: 14/170,421

(22) Filed: Jan. 31, 2014

Related U.S. Application Data
(60) Provisional application No. 61/759,271, filed on Jan. 31, 2013.

(51) Int. Cl. B60R 22/32

(52) U.S. Cl. CPC B60R 22/322; B60R 22/321
USPC 24/603

(57) ABSTRACT

The invention provides an electronic assembly that disengages an automobile seat belt lock following an impact. The Seatbelt Safety Release device is installed directly into the seatbelt locking bay and is equipped to automatically release the belt five seconds after impact by means of sensors located in the bumper and fenders of an automobile which send a signal to a receiver activating a solenoid to disengage the seatbelt lock upon sensing an impact.

### CLAIM OF PRIORITY

This patent application claims priority under 35 USC 119 (e) (1) from U.S. Provisional Patent Application Ser. No. 61/759,271 filed Jan. 31, 2013, of common inventorship herewith entitled, “Seatbelt Safety Release.”

### FIELD OF THE INVENTION

The present invention pertains to the field of automotive safety devices, and more specifically to the field of seatbelt release devices.

### BACKGROUND OF THE INVENTION

The prior art has put forth several designs for seatbelt release devices. Among these are:

U.S. Pat. No. 4,574,911 to Lawrence A. North describes a seat belt buckle emergency release system that is electrically actuated after the vehicle has come to rest.

U.S. Pat. No. 4,162,715 to George Coulonbe describes an automatic releasing seat belt. Upon impact, the sensors operate a timer which disposes the solenoid into an activated condition releasing all of the belt mechanisms electrically coupled to it.

U.S. Pat. No. 5,181,738 to Shigeichi Shimizu describes an automatic seat belt unlocking device mechanically configured with a lock box structure, a mounting structure and a releasable device which is operably connected between the mounting structure and the locking lever.

None of these prior art references describe the present invention.

### SUMMARY OF THE INVENTION

It is an object of the present invention to provide an improved seatbelt release device.

### BRIEF DESCRIPTION OF THE DRAWINGS

FIG. 1 is an elevational angled perspective view of the device of the present invention in mounted in an automobile showing diagnostic module, shock sensors tied to front and rear passenger belts and air bags.

FIG. 2 is an elevational angled perspective view of the device of the present invention in mounted in an automobile showing the RF emitter under the dash, tie in to shock diagnostics, module options and buckle options.

FIG. 3 is an elevational front view of the device of the present invention in mounted in an automobile showing the seat belt buckle attachment and adapter.

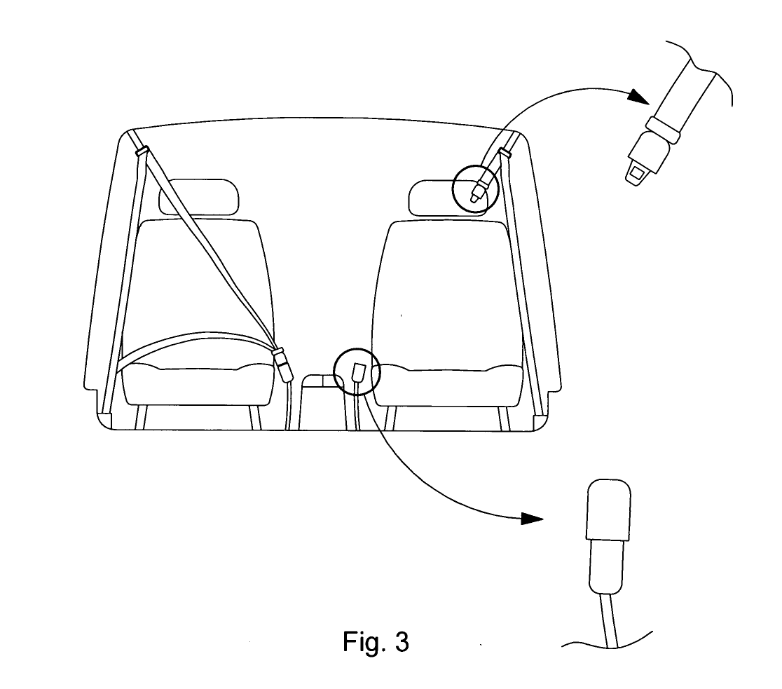

FIG. 4 is an exploded view of the device of the present invention mounted on a seat belt buckle.

FIG. 5 is a top view of the device of the present invention mounted on a seat belt buckle.

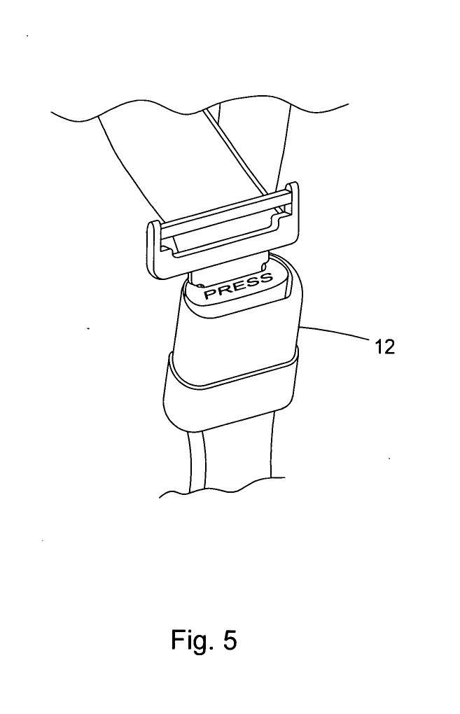

FIG. 6 is a front view of the device of the present invention mounted on a seat belt buckle showing internal components in shadow.

FIG. 7 is a front view of the device of the present invention showing internal components.

### DETAILED DESCRIPTION OF THE INVENTION

The most important and useful of all automotive safety devices is the common seat belt. Designed to restrain both drivers and passengers during a crash, seat belts are found in the vast majority of cars, buses and trucks on the road. During a crash, properly fastened safety belts distribute the forces of rapid deceleration over larger and stronger parts of a person's body, such as the hips, chest and shoulders. Stretching slightly to slow the body down and increase stopping distance, a properly buckled seat belt is crucial to the well being of those involved in minor fender benders and severe automobile crashes alike.

Although wearing a seat belt when traveling in a car, van or truck is a key factor in surviving an accident and is in fact, mandatory in most states, these safety implements present a drawback. In the event of an impact, there are times that the seat belt turns the motorist into a virtual prisoner. Impossible to release, the seat belt traps the occupants of the vehicle, making it difficult for them to escape the wrecked car and for rescue personnel to free them. It is an extremely scary, and potentially deadly, scenario when one is trapped in a burning vehicle or submerged in water and is unable to get to safety because of being trapped by a seat belt.

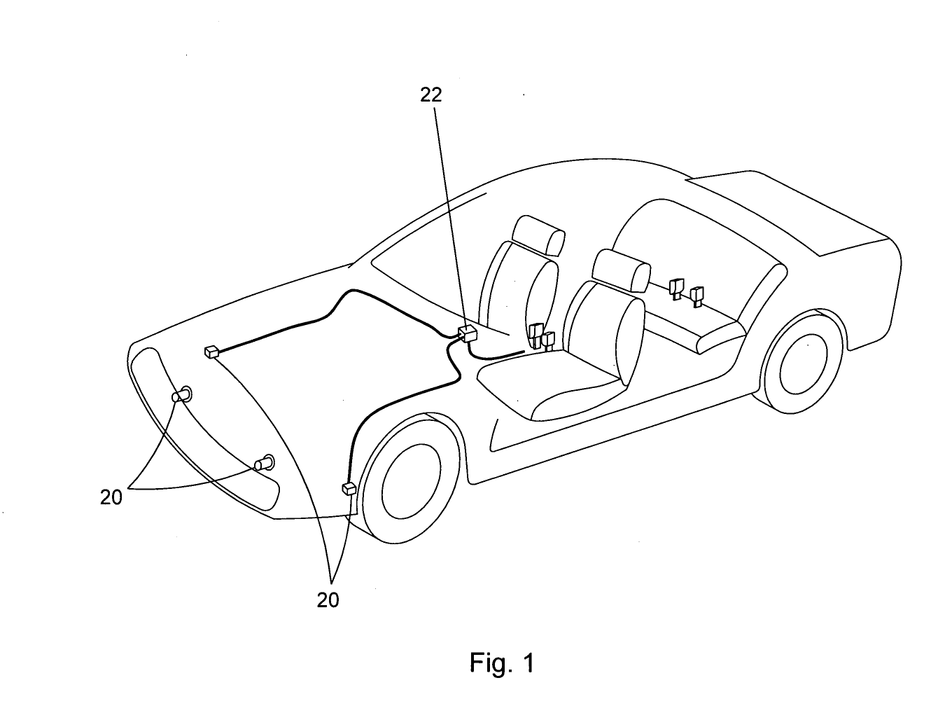

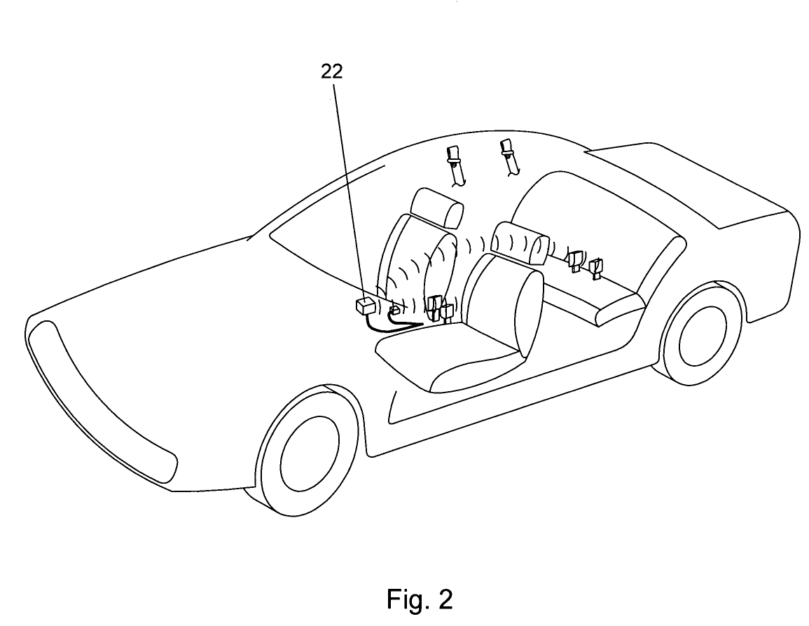

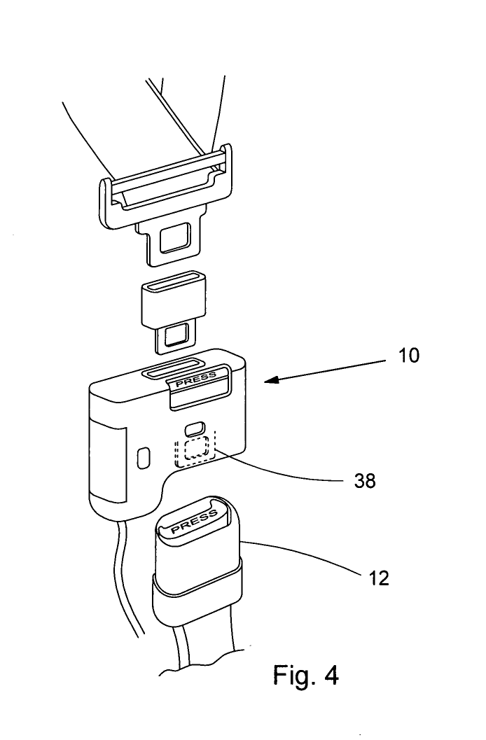

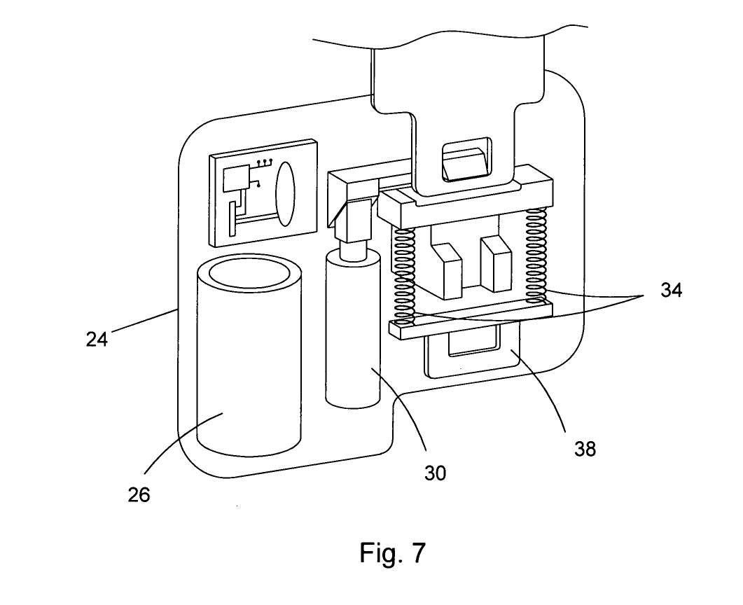

The present invention, hereinafter referred as the Seatbelt Q-Release, or Seatbelt Safety Release is an electronic assembly that disengages the seat belt lock following an impact. The Seatbelt Safety Release device 10, shown in FIG. 4, is installed directly into the seatbelt locking bay 12, and is equipped to automatically release the belt five seconds after impact. Please refer to FIGS. 1 and 2. Impact is detected by sensors 20 installed in the bumpers and fenders of the automobile. Upon impact, the sensors 20 detect the impact and send a signal by means of diagnostic module 22 to the device 10. This action is achieved via a transmitting and receiving system, which constitutes the Seatbelt Safety Release device 10. The device 10, shown in FIG. 7, comprises a small electronic unit featuring a transmitter, frequency generator, amplifier, internal antenna, and electrical/electronic components with respective circuitry encased within a durable plastic housing 24. Also enclosed within the plastic housing 24 is a small replaceable battery 26 that powers the unit. The receiver consists of a tuned frequency, receiver circuit, and replaceable battery. When a crash occurs, the transmitter unit 22 generates and transmits a signal. The companion receiving unit contained within device 10 is tuned to the specific frequency generated by the transmitter unit 22. Upon reception of the signal generated by the transmitter 22, the circuitry in the receiver generate an ‘enable’ signal to a logic device, an ‘AND’ integrated circuit chip or comparable, which applies a voltage level to the seatbelt lock, causing the system to be activated. This action, activates solenoid 30, which in turn, disengages the lock, by activating springs 34 which push out the latch, freeing the motorist from the seat belt.

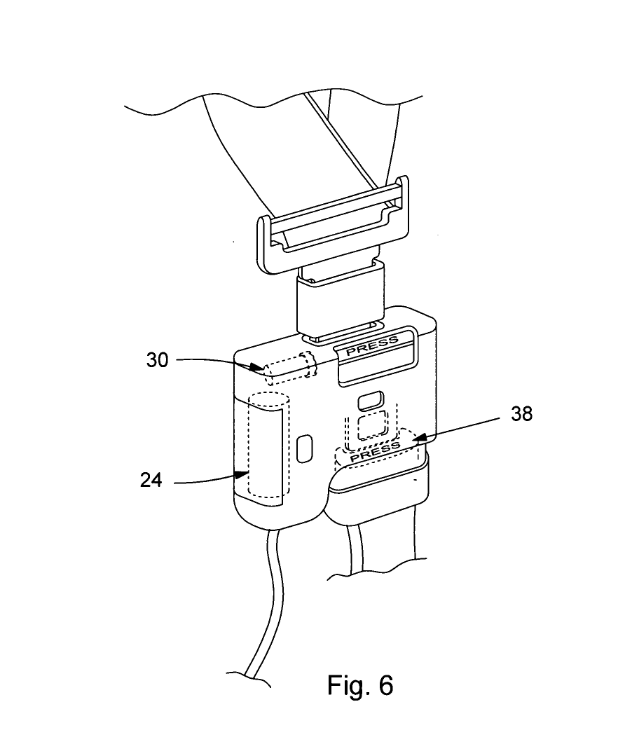

FIG. 6 shows an alternative embodiment wherein the solenoid 30 is positioned in device 10 in different position than that shown in FIG. 7.

The Seatbelt Safety Release saves many lives, regardless of the severity of the accident. Facilitating a motorist's own escape as well as easing the efforts of professional rescue personnel, the product of the current invention proves an ideal addition to any vehicle, whether car, truck, van, RV, SUV, bus, and airplane.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A seatbelt release device comprising: an electronic assembly that disengages a seat belt lock following an impact wherein the device is installed directly into a seatbelt locking bay, and is equipped to automatically release the seatbelt five seconds after impact.

2. The device of claim 1 further comprising sensors installed in bumpers and fenders of an automobile, whereupon impact, the sensors detect the impact and send a signal by means of a diagnostic module to the device, wherein the diagnostic module comprises a transmitter, frequency generator, amplifier, internal antenna, and electrical/electronic components with circuitry, all encased within a durable plastic housing.

3. The device of claim 3 further comprising a receiver wherein the device installed in the seatbelt locking bay comprises a receiver consisting of a tuned frequency, receiver circuit, solenoid, at least one spring and replaceable battery.

4. The device of claim 2 wherein the transmitter unit generates and transmits a signal to a receiver, wherein the receiver is contained within device installed in the seatbelt locking bay, and said receiver is tuned to a specific frequency generated by the transmitter, whereupon reception of a signal generated by the transmitter, circuitry in the receiver generates an ‘enable’ signal to a logic device, an ‘AND’ integrated circuit chip or comparable, which applies a voltage level to a seatbelt lock, activating a solenoid which disengages the seatbelt lock by activating springs which push out a latch in the seatbelt lock, freeing a motorist from the seat belt.
